(19) United States
(12) Patent Application Publication
(10) Pub. No.: US 2018/0272380 A1
(43) Pub. Date: Sep. 27, 2018

(54) ROLLER DEVICE

(71) Applicant: Orkla House Care AB, Bankeryd (SE)

(72) Inventors: Kristoffer Apelstedt, Jönköping (SE); Martin Qvänstedt, Bankeryd (SE); Janarne Wetterheim, Bankeryd (SE)

(21) Appl. No.: 15/537,618

(22) PCT Filed: Dec. 17, 2015
(86) PCT No.: PCT/SE2015/051365

§ 371 Date: Jun. 19, 2017

(30) Foreign Application Priority Data
Dec. 19, 2014 (SE) 1451609-0

(51) Int. Cl. B05C 17/02

(52) U.S. Cl. CPC B05C 17/02

(57) ABSTRACT

The invention is relative to a roller bracket for cooperation with a cylindrical paint roller, comprising a handle and a bracket rod, and is also relative to a roller end piece. The roller end piece is wheel-shaped and has a substantially cylindrical envelope surface and a bearing for mounting on the bracket rod, wherein two roller end pieces are mounted on the bracket rod. An outer roller end piece is arranged at the end of the bracket rod and an inner roller end piece, which comprises a carried wheel with a push-off element, is arranged at distance form the outer roller end piece for removably carrying a respective end of paint roller on its respective substantially cylindrical envelope surface.

### TECHNICAL FIELD

The present invention is relative to a device for removing a paint roller from a roller bracket. More particularly, the invention concerns a roller bracket comprising a wheel and a displaceable push-off element allowing removal of the paint roller from the roller bracket without touching the paint roller.

### BACKGROUND

Prior art roller brackets are provided with inner and outer roller end pieces having as function to secure retention of the paint roller and being supported to allow retention of the paint roller. To prevent a paint roller from sliding too far on the inner roller end piece, the latter is often provided with a counter-element against which the paint roller bears. To give sufficiently strength and rigidity to the roller end piece, roller end pieces according to the state of the art often contains spokes extending radially and axially towards a hub and being attached to the hub, which is mounted directly on the bracket rod of the roller bracket.

In normal use of a roller bracket, its paint roller is covered with paint to remove the paint roller from the roller bracket, one has earlier been forced to get in contact directly with the paint roller, which thus results in the user getting dirty. Previously, it has also been difficult to push the roller off manually. In prior art, paint having penetrated into the rotating divide of the roller bracket has caused a degradation of the rotational capacity of the rotating divides, so they jammed and the paint roller therefore cannot rotate as intended at the painting, resulting in a less satisfying painting.

JP 2000254578 describes a known device for removing a paint roller from a roller bracket by means of a push-off element.

### SUMMARY OF THE INVENTION

It is an object of the invention to solve or at least reduce the problems mentioned here above.

Another object is to provide a cleaner handling by using a device making it possible to remove/disconnect the paint roller without touching the same.

It is an object to provide a cleaner handling by using a device that reduces the penetration of paint into the roller end piece.

It is a further object to provide a cleaner handling by using a device that reduces the risk for paint to flow along the bracket rod towards the handle.

It is a further object to provide a roller end piece that constitutes an assembled unit, which eliminates the need for separate and loose details.

It is a further object to provide a roller end piece that constitutes an assembled unit, which simplifies the mounting of, and storage of the comprised components constituting the roller end piece after assembly of the same.

It is an object to provide a roller end piece that reduces the risk of the roller end piece's rotation ability being impeded or degraded at by high load.

It is a further object to provide a roller end piece that reduces the risk that the rotating divides of the roller end piece jam at high load and cannot rotate around the bracket.

These objects are fully or partly achieved by means of a roller bracket and a roller end piece according to the independent patent claims, wherein preferred variants of the roller bracket and of the roller end piece being defined in the associated dependent patent claims.

The roller bracket according to the invention is adapted to cooperate with a cylindrical paint roller, comprising a handle and a bracket rod, in which said roller bracket comprises an outer roller end piece arranged at the end of the bracket rod, and an inner roller end piece arranged at a distance from the outer roller end piece, said roller end pieces being arranged to removably carry the paint roller, said inner roller end piece comprising a wheel and a push-off element, whereby the wheel is rotatably mounted and axially movable between two positions, characterized in that the push-off element is rotatably mounted on the wheel and axially movable between two positions on the wheel, wherein said positions for the push-off element is defined by two stop elements on the wheel.

The roller bracket may include a handle, a bracket rod and cooperate with a cylindrical paint roller. The roller bracket comprises two roller end pieces mounted on the bracket rod, an outer roller end piece being arranged at the end of the bracket rod and an inner roller end piece being placed at a distance from the outer roller end piece for supporting a respective end of the painting tube on its respective substantially cylindrical envelope surface. The envelope surface of the inner roller end piece has a number of ribs distributed around the periphery of the envelope surface. Each rib has the shape of a rounded out point that is radially thickest at the inner end of the inner roller end piece and tapers towards the point. The inner roller end piece may comprise a wheel, a push-off element and a bearing for mounting onto the bracket rod. The wheel and the push-off element may be rotatably arranged on the bearing that is fixed in the axial direction of the bracket rod after mounting. Any movement of the wheel in axial direction is limited by the bearing. The push-off element is slidably arranged in relation to the wheel.

According to one aspect, the wheel is rotatably mounted and axially movable between two positions on the bracket rod. According to one aspect, the roller end piece comprises a bearing for mounting in the wheel. According to one aspect, the roller bracket end pieces comprises a bearing for mounting on the bracket rod. According to one aspect, the bearing is arranged to be fixed non-rotatably on the bracket rod. According to one aspect, the bearing extends through the wheel. According to one aspect, the bearing extends through the entire axial length of the wheel. According to one aspect, the bearing is arranged to limit the movement of the wheel in axial direction by means of snap locks. According to one aspect, the bearing is arranged to limit the movement of the wheel in axial direction by means of a snap lock at one of its ends and a stop at the other end. According to one aspect, the push-off element comprises an annular projection along the outer circumference of the push-off element, which annular projection extends in the direction of the wheel after assembly of the wheel and the push-off element, wherein the diameter of the annular projection is larger than the diameter of the wheel and adapted to substantially correspond to the diameter of the paint roller. According to one aspect, the bearing is provided with at least one longitudinal groove that splits or divides the bearing in the longitudinal direction of the bearing. According to one aspect, the wheel is provided with at least one longitudinal groove that splits or divides the wheel in the longitudinal direction of the wheel. According to one aspect, the at least one longitudinal groove of the wheel splits or divides an end of the wheel. According to one aspect, the wheel is arranged to limit the movement of the push-off element in axial direction by means of stop elements n form of an abutment at one of its ends and in form of a stop element at its other end. According to one aspect, the stop element of the wheel is in form of at least one lug. According to one aspect, the movement of the wheel in axial direction is limited by the bearing. According to one aspect, the wheel is rotatably mounted on the bearing. According to one aspect, the wheel is rotatably mounted on the bearing and the wheel is in contact with at least one specific bearing/sliding surface of the bearing. This specific bearing/sliding surface may be one or several elevated surfaces on the envelope surface of the bearing. According to one aspect, the wheel comprises a substantially cylindrical envelope surface, which is provided with a number of ribs distributed around the circumference of the envelope surface, wherein each rib has the shape of a rounded out point that is radially thickest at an end of the wheel and tapers toward the point in direction toward an another end of the wheel. According to one aspect, the push-off element comprises a substantially cylindrical hub that together with the annular projection of the push-off element provides a circumferential cup-like configuration.

According to one aspect, the wheel is rotatably arranged on the bearing and its push-off element is rotatably arranged on the wheel. According to another aspect, the movement of the push-off element in the axial direction is limited by the bearing and the wheel. According to one aspect, the bearing is provided with a longitudinal groove that partly splits the bearing in it longitudinal direction.

The invention provides an improved roller end piece comprising rotating divides that are disconnected from each other because of the fact that the push-off element is separately carried on the wheel. The invention provides an improved roller end piece comprising rotating divides that are disconnected from each other by the fact that the wheel is separately carried on the bearing. The invention provides an improved roller end piece comprising rotational divides that are disconnected from each other by the fact that the push-off element is separately carried on the wheel and the wheel is in its turn carried separately on the bearing. The invention provides an improved roller end piece comprising a rotating and slidable push-off element disconnected from the wheel and from the bearing, the push-off element being able to independently of the load on the roller end piece, is able to rotate relative to the wheel and the bearing, but which also can rotate with the wheel, but not with the bearing. The invention provides an improved roller end piece comprising a rotating wheel disconnected from the push-off element and from the bearing and which independently of the load on the roller end piece can rotate relative to the push-off element and to the bearing, but which also can rotate with the push-element but not with the bearing. The invention provides by the above mentioned disconnection of the rotating divides comprised in the roller end piece a reduced risk for the rotating divides to seize in/against each other at high load and then cannot rotate around the bracket. The invention provides by the above-mentioned disconnection of the rotating divides comprised in the roller end piece a reduced risk for the rotating divides at high load not to be able to rotate around the bearing on the bracket.

The effect of invention is among others that a cleaner handling of the roller bracket is achieved in that the paint roller can be removed without touching the paint roller when pushing in off. The invention further provides for simpler mounting by means of fewer components and assembling steps by means of the bearing that is fixed in axial direction on the bracket rod and functions as an axial stop in itself for the roller end piece. The bearing is held in place axially by friction against the bracket rod. The invention further provides for easier mounting by eliminating separate divides as the bearing serves as a common holding together attachment for the other components comprised in the roller end piece, such as the wheel and the push-off element. Furthermore, the bearing is non-rotatably fixed on the bracket rod by friction so that any additional, separate locking and/or holding together details such as axial stops in form of integrated upsettings/beads of the bracket rod itself are not needed for keeping the roller end piece in place on the bracket rod. The invention also provides integrated and built-in locking functions in the bearing itself that makes the roller end piece to an assembled unit without any need for neither loose locking rings for axial fixation nor supplementary fasteners for mounting on the bracket rod itself. The user can, by means of the invention, slide the push-off element against the outer roller end piece and thereby move the paint roller with regard to the roller end pieces and thus release, i.e. push the paint roller off from the roller bracket without touching the paint-laden paint roller. The user can push the push-element against the outer roller end piece and thereby move the paint roller relative to the roller end pieces to relieve, i.e. push the paint roller off from the roller bracket without the physical effort becoming overwhelming, at least not on the long run. The invention provides an integrated/built-in and improved rotary bearing function on the bearing itself which ensures that the paint roller can rotate even if paint penetrates into the rotating divides comprised in the roller end piece. The invention provides an integrated/built-in and improved rotary bearing function through the design of the envelope surface of the bearing itself which ensures that the paint roller can rotate during use without being adversely affected by paint penetrating into the roller end piece, which undesirable paint results in the rotating divides comprised in the roller end piece jamming, for instance by drying/dried paint having flowed into the wrong place. The paint roller comprises a paint delivering material.

### DESCRIPTION OF THE DRAWINGS

The invention will here below be described with reference to the accompanying drawings, in which

FIG. 1 is a perspective view of a roller bracket and a roller end piece,

FIG. 2 is an exploded lateral view of a roller bracket and a roller end piece,

FIG. 3 is a sectional view of a push-off element,

FIG. 4 is a sectional view of the roller end piece,

FIG. 5 is a partial view of the sectional view of the roller end piece in FIG. 4 where the push-off element is in an end position before dismounting/under use of a paint roller,

FIG. 6 is a perspective view of a wheel, and

FIG. 7 is a partial view of the perspective view of the wheel in FIG. 6.

### DESCRIPTION OF EMBODIMENTS

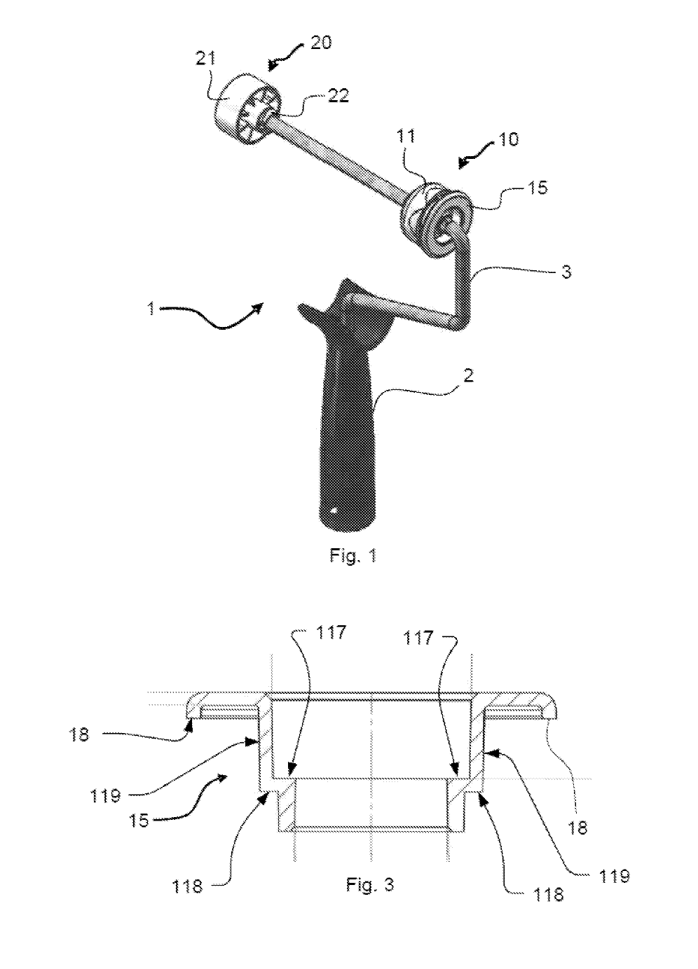

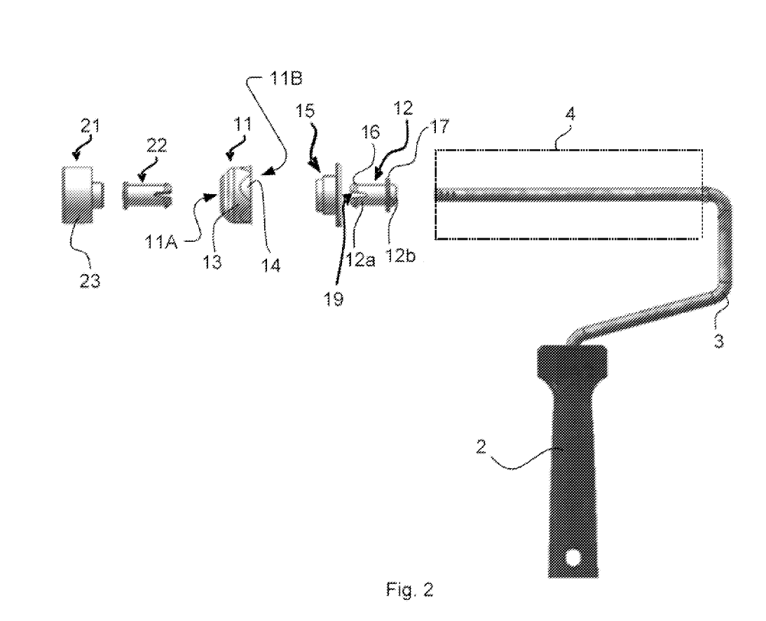

Thus, the present invention provides a roller bracket 1, which advantageously holds a paint roller 4 (schematically shown in FIG. 2), and allows the user to remove the paint roller 4 without touching it. FIG. 1 shows a roller bracket 1 supporting the paint roller 4, which paint roller 4 has an absorbing surface to apply to and deliver paint at painting works. The roller bracket 1 comprises a handle 2, a bracket rod 3 and an outer and an inner roller end piece 20, 10. The paint roller 4 is supported by the roller end pieces 10, 20, i.e. one outer roller end piece 20 and one inner roller end piece 10. The roller bracket 1 is held by the painter by the handle 2 that can have a more or less ergonomically elaborate design, and may be provided with supports etc. as is conventional in the art.

The roller bracket 1 and the inner roller end piece 10 are described hereinafter with reference to FIGS. 1-7.

According to one aspect, the inner roller end piece 10 comprises a wheel 11 and a push-off element 15. The wheel 11 comprises a through hole 111. The through hole 111 of the wheel and the outer dimensions of the bracket rod 3 are adapted to each other so that the wheel 11 can be mounted on the rod. The through hole 111 of the wheel 11 is adapted to the outer dimensions of the bracket rod so that the wheel 11 can rotate around the rod after mounting onto the bracket rod 3. Furthermore, the movements of the wheel 11 may be limited in the longitudinal extension of a bracket rod 3 by stop elements, e.g. by an upsetting on the rod as an end stop in one direction and another upsetting on the rod as an end stop in the other direction.

The push-off element 15 is mounted on the wheel 11. The inner roller end piece 10 is assembled by pushing/inserting the push-element 15 into the wheel 11 from the other end 11B of the wheel. Then the wheel 11 and the push-off element 15 are pressed together on the bracket rod 3 so that the wheel 11 and the bracket rod form a cohesive unit, i. e. the inner end piece 10. Then, the inner roller end piece is mounted onto the bracket rod 3 by slipping onto the same and is axially maintained in place by the above mentioned stop element between the ends/bendings of the bracket rod 3 and the roller end piece 10.

According to one aspect, the inner end piece 10 comprises a bearing 12 that comprises a snap lock 16 and a stop 17, a wheel 11 that comprises an envelope surface 13, and a push-off element 15. The push-off element 15 comprises an annular projection or ridge 18. The wheel 11 comprises a central hub 110 having a through hole 111. The through hole 111 of the wheel and the outer dimensions of the bearing 12 are adapted to each other so that the bearing can be introduced into the wheel 11. The through hole 111 of the wheel is adapted to the outer dimensions of the bearing 12 so that the wheel 11 is able to rotate around the bearing after mounting onto the bracket rod 3. The wheel 11 presents a first end 11A directed towards the outer roller end piece 20 when the inner roller end piece 10 is mounted on the bracket rod 3. The wheel 11 presents a second end 11B directed away from the outer roller end piece 20 when the inner roller end piece 10 is mounted on the bracket rod 3. The wheel 11 may comprise a number of ribs 14 on its envelope surface 13.

The inner roller end piece 10 is assembled by the push-off element 15 being pushed/introduced into the wheel 11 from the other end 11B of the wheel. The wheel 11 and the push-off element 15 are then pressed together on the bearing 12. The wheel 11, the push-off element 15 and the bearing 12 then form a cohesive unit, i.e. the inner roller end piece 10. Then the inner roller end piece 10 is mounted on the bracket rod 3 by press and is kept in place/fixed by the friction between the bracket rod 3 and the bearing 12. The wheel 11 is mounted onto the bearing 12, i.e. the bearing 12 is adapted to be mounted in the wheel 11, which is arranged to be rotatable around the bearing 12. Furthermore, the wheel 11 is arranged to be limited with regard to its movements in the longitudinal extension of the bracket rod 3 by the snap lock 16 of the bearing 12 in one direction and by the stop 17 in the other direction. To simplify the mounting of the wheel 11 on the bearing 12, the bearing 12 is provided with at least one or several longitudinal grooves 19 in form of a slot or a recess along divide of its length. The groove or grooves 19 divide or split the bearing 12 in a plane parallel with its central axis in at least one or several sections. The section or sections are extending parallel with the longitudinal direction of the bearing 12. The section or sections extend so deeply from one end 12a of the bearing 12 that the snap lock 16 is given resilient properties. Thus, the bearing 12 presents at least two free end portions at its end 12a, which end portions bend with regard to each other when the bearing 12 is not mounted on the bracket rod 3 like a mouth where the snap lock jaws can move relative to each other and radially relative to the bearing 12. This provides a better locking. The section does not extend over the whole length of the bearing. The bearing 12 is locked/secured against the wheel 11 by the snap lock 16 protruding through the hole orifice of the wheel 11 past the first end 11A of the wheel and then bends/snaps out on the other side of the wheel 11. By the application of a snap lock and a stop on a through bearing 12, a composed roller end piece 10 is provided where the number of divides is minimized and which unit can easily be handled when it is not mounted on the bracket rod 3. The stop 17 and the snap lock 16 of the bearing constitutes further integrated and built-in abutments and interlocked divides and eliminate the need for separate locking elements such as locking rings or the like.

The ribs 14 of the wheel 11 are arranged to cooperate by friction with the paint roller 4 to prevent unwanted movement of the paint roller 4 relative to the wheel 11. The ribs 14 have the shape of a rounded out point that is radially thickest at the inner end of the inner roller end piece 10, i.e. at the other end 11B of the wheel, and the point tapers in direction of the outer roller end piece 20, i.e. in direction of the first end 11A of the wheel.

The ribs 14 on the envelope surface 13 of the wheel cause friction between the paint roller 4 and the envelope surface 13. This friction between the wheel 11 and the paint roller 4 provides a reliable holding of the paint roller 4 against the roller end piece 10 after the mounting of the same on the roller bracket 1 for the desired “co-rolling” of the paint roller 4 and the wheel 11 at painting, while the threading on and removal of the paint roller 4 is optimized without requiring excessive force at the pushing on or off of the paint roller 4.

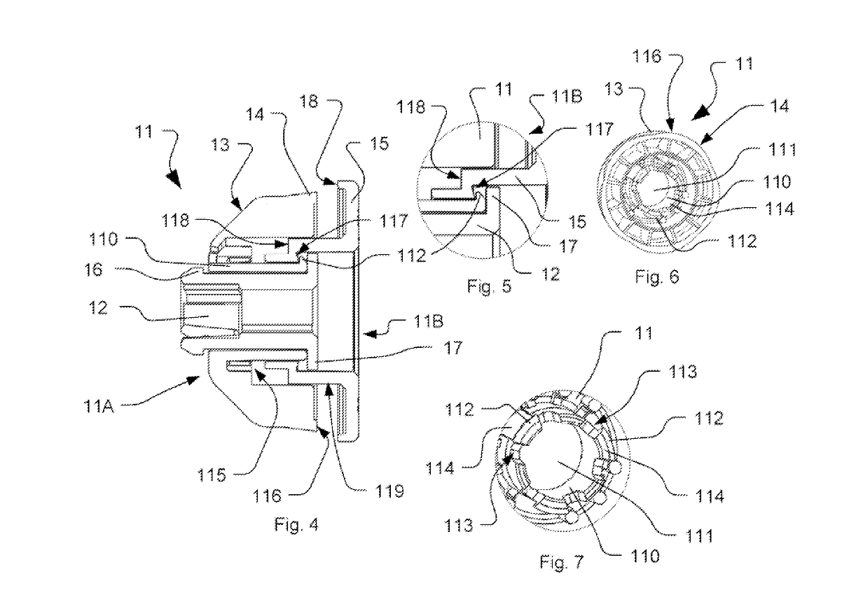

Furthermore, the hub 110 of the wheel 11 is provided with stop elements 112, 115 (see FIGS. 4, 5, 6 and 7). The stop elements 112 and 115 on the hub 110 of the wheel serve as axial abutments for the push-off element 15 when fitted in the wheel 11. The stop elements 112 and 115 on the hub 110 function as stops for the push-off element 15 in axial direction after mounting on the wheel 11. The stop elements 112, 115 on the hub 110 of the wheel function to stop the axial displacement of the fitted push-off element 15 relative to the wheel 11 in the end position. A first stop element 111 of the wheel hub 110 is in shape of at least one lug at one end 11B of the wheel 11. The first stop element 112 comprises at least one lug provided at one end of the hub at the other end 11B of the wheel. This first stop element 112 may be one or more lugs. This first stop element 112 is at least one lug projecting radially from the hub end at the other end 11B of the wheel. The first stop element 112 limits the movement of the push-off element 15 in the longitudinal extension of the bracket rod 3 similarly to the snap lock 16 of the bearing in one direction, i.e. in one of the end positions. The movements of the push-off element 15 in the longitudinal extension of the bracket rod 3 in the other direction is limited by a second stop element 115 at the first end 11A of the wheel in the end position. The stop element 115 limits the movements of the push-off element 16 in the longitudinal extension of the bracket rod in the direction of the outer roller end piece 20, i.e. in the other end position. The second stop element 115 may be divide of the inside of the wheel 11 at its first end 11A. This second stop element 115 may be an internal wall portion of the inside of the wheel 11 at its first end 11A. The second stop element 115 may be an abutment on the inside of the wheel 11 at its first end 11A.

To simplify the mounting of the push-off element 15 onto the wheel 11, the second end 11B of the wheel is provided with at least one groove or a slot or a recess 113. The groove or grooves 113 extend along the length of the end 11B. The groove or grooves 113 divide or split the other end 11B of the wheel 11, at least along a portion of the length of the end. The groove or grooves 113 divide or split the other end 11B of the wheel concentrically, at least along a portion of the length of the end. The groove or grooves 113 divide or split the other end 11B of the wheel eccentrically, at least a long a portion of the length of the end. The groove or grooves 113 divide or split the other end 11B of the wheel concentrically, at least along a portion of the length of the end in a plane parallel to the longitudinal direction of the wheel. The groove or grooves 113 divide or split the other end 11B of the wheel diametrically. The groove or grooves 113 may divide or split the other end 11B of the wheel diametrically through its central axis. The groove or grooves 113 may divide or split the other end 11B of the wheel diametrically through its central axis in one section. The groove 113 may divide or split the other end 11B of the wheel in one or several sections, preferably in an even number of sections, i.e. two or four or more section, but it may also be split into an uneven number of sections, i.e. one or three section or more. The groove or grooves may extend in parallel with the longitudinal direction of the wheel. The section or sections are so deep into the other end 11B of the wheel 11 so that the snap lock function of the stop element 112 is achieved with resilient properties. Thereby, the wheel 11 is at its other end 11B provided with on or two, three, four, five or six or more free end portions 114. These end portions 114 may bend with regard to each other when the wheel 11 is not mounted on the bracket rod 3. The end portions 114 may bend like a mouth where the snap lock jaws can move/bend with regard to each other and radially with regard to the wheel 11. The end portions 114 thereby function as a snap lock similar to the snap lock 16. This provides a better locking. The section or sections do not extend over the whole length of the wheel.

Each of the end portions 114 is provided with at least one end element or stop element or lug 112. Each end portion 114 with its stop element 112 limits movements of the push-off element 15 in the longitudinal extension of the bracket rod by stopping the movement of the push-off element in an axial end position. Each stop element 112 limits the movements of the push-off element 15 by acting as an end stop in one of the axial directions. Each stop element 112 limits the movements of the push-off element 15 by acting as an end stop in a direction from the first end 11A of the wheel and the outer roller end piece 20 when the roller end pieces 10 and 20 are mounted on the bracket rod 3.

The push-off element 15 is provided on the wheel 11 in a rotatable manner and arranged to be moved towards and from the wheel 11 along the longitudinal extension of the bracket rod. The axial movement of the push-off element 15 is limited in one direction by the stop 115 of the wheel 11. The axial movement of the push-off element 15 is limited in the other direction by the stop element 112 of the wheel in the end position at the other end 11B of the wheel. This means that the push-off element 15 is partially axially displaceable relative to the wheel 11. The push-off element 15 is at least partially axially displaceable relative to the bearing 12.

By the application of a snap lock 112, 113, 114 and a stop 115 on the wheel 11, an assembled composite roller end piece unit 10 is achieved in which the number of divides is minimized. This unit, i.e. the inner roller end piece, can easily be handled when it is not mounted on the bracket rod 3. The snap locks 112, 113, 114 of the wheel having a snap lock function further constitute integrated, bendable and built-in abutments and interlocking divides and eliminate the need for separate lock divides such as locking rings or the like. Through the application of a snap lock 16 and a stop on a traversing bearing 12 is a composite roller end piece assembled unit 10 achieved where the number of divides is minimized and which unit can easily be handled when it is not mounted on the bracket rod 3. Bearing stop 17 and snap lock 16 further constitute integrated and built-in abutments and interlocking divides and eliminate the need for separate locking elements such as locking rings or the like.

The inner diameter of the annular projection 18 is larger than the outer diameter of the wheel 11 and substantially corresponds to the diameter of the paint roller 4. The annular projection 18 is shaped in such a way that when the push-off element 15 bears against the wheel 11, the projection 18 extends over the highest divide of the ribs 14. This ensures that the paint roller 4 comes out of engagement with the inner roller end piece 10 when the push-off element 15 is pushed against the wheel 11. This is done by the projection/ridge 18 of the push-off element 15 being moved with sufficient force in axial direction along the inner roller end piece 10 towards the outer roller end piece 20 to at least partially bear against one end/end ridge of the paint roller 4. The projection/ridge 18 of the push-off element 15 is moved axially along the wheel 11 and the bracket rod 3 to at least partially bear against the painting tube 4. At further displacement of the projection/ridge 18 of the push-off element in the same direction, i.e. in the direction of the outer roller end piece 20, the inner side of the paint roller is pressed/pushed from/past the outer ridge 116 of the wheel and out of contact with the ribs 14 and is loosened from the wheel 11. Thereby, the paint roller 4 is loosened from the inner roller end piece 10, but also from the outer roller end piece 20 and from the entire bracket 1. Furthermore, the ridge of the projection 18 does not need to be in supporting abutment against the wheel 11 all the time.

As shown in FIGS. 3, 4 and 5, the push-off element 15 is rotatably symmetrical. The push-off element 15 is formed with two substantially cylindrical internal surfaces with different diameter. The internal cylindrical surface having the smaller diameter is adapted to slide on the wheel 11 and stabilize the push-off element 15 against tilting. The internal cylindrical surface having the largest diameter is adapted to accommodate the stop element 112. The internal cylindrical surface having the largest diameter creates a hub 19 for the push-off element 15. This hub 119 is substantially cylindrical and creates together with the annular projection of the push-off element 15 a circumferential cup-like configuration (see FIGS. 3 and 4). The hub 119 of the push-off element presents a substantially cylindrical outer surface, which together with the push-off element is pushed into and out from the wheel 10 when the push-off element 15 is moved (see FIGS. 3 and 4). The hub 119 of the push-off element has an outer diameter that is adapted to cooperate with a cavity in the wheel so that the hub of the push-off element can be moved inside the wheel 10 when the push-off element 15 is moved. The internal cylindrical surface having the larger diameter is also adapted to accommodate the stop 17 of the bearing and further stabilize the push-off element 15. In the transition between the above-mentioned internal cylindrical surfaces, an internal shoulder surface 117 is formed directed towards the other end 11B of the wheel. This internal shoulder surface 117 is adapted to butt against the stop element 112 of the wheel in the end position. Thereby, the movement of the push-off element 15 is limited in the direction from the inner roller end piece 5. The internal cylindrical surface having the largest diameter may be adapted partly to bear against the stop 17 of the bearing in the end position to thereby further stabilize/control the linear/axial movement of the push-off element 15 in the direction from and towards the inner roller end piece 10. In the transition between the above-mentioned internal cylindrical surfaces, an external shoulder surface 118 is also formed, relatively to the push-off element on the opposite/outer side of the internal shoulder surface 117 (see FIGS. 3, 4 and 5). This external shoulder surface 118 is facing the first end 11A of the wheel, see FIGS. 4 and 5. The external shoulder surface 118 may be adapted to bear against/contact the stop 115 of the wheel in the end position thereby to limit the movement of the push-off element 15 in the direction into and against the inner roller end piece 10 and the outer roller end piece 20.

When a paint roller 4 has been mounted, the push-off element 15 serves as an abutment for the paint roller as the paint roller can bear against/“touch the bottom” against the annular projection 18 when the push-off element 15 in turn bears against the stop element 112 of the wheel in its end position.

In the following, the function of the roller bracket 1 will be described more in detail. When a paint roller 4 is to be mounted onto the roller bracket 1, it is first brought over the outer roller end piece 20. The outer diameter of the outer roller end piece is so designed in relation to the inner diameter of the paint roller 4 that it can be easily threaded thereon. Then, the paint roller 4 is moved along the bracket rod 3 against the inner roller end piece 10. When the paint roller presses against the ribs 14, then the ribs 14 will bend off inwardly and thereby create a friction between the outer side of the envelope surface 13 of the wheel 11 and the inside of the paint roller 4. The paint roller 4 is thereafter moved further in on the bracket rod 3 and comes then in contact and lies the flush with the annular projection 18 on the push-off element 15. Finally, the paint roller 4 is moved further inwards and will displace the push-off element 15 away from the wheel 11. When the push-off element 15 attains its end position, i.e. when it bears against the stop lug/lugs/stop element 112 at the end 11B of the wheel 11, then paint roller 4 is mounted on the roller bracket 1. In practice, the above steps are carried out in a sweeping motion and the interaction between the different divides take place automatically and more or less continuously.

As the user paints, the paint roller 4 will come into contact with paint while the push-off element 15 in principle does not come into contact with paint at normal use of the roller bracket 1.

When the user then desires to remove the paint roller 4 from the roller bracket 1 without grasping the paint roller 4, the following steps are carried out. The user pushes the push-off element 15 in direction towards the wheel 11, e.g. by pushing the push-off element 15 against a paint bottle or any other abutment.

The annular projection 18 of the push-off element 15 is thereby also pressed against the paint roller 4 that follows the movement of the push-off element and the push-off element 15 is moved together with the paint roller against the wheel 11. When the push-off element 15 is further pressed against the wheel 11, then the projection 18 will partly be moved over the wheel 11 and over its ribs 14 and the outer ridge/corners 116. The annular projection 18 thereby presses the paint roller 4 entirely out of cooperation with the ribs 14. As the wheel 11 thereby will not be in cooperation with the roller tube 4, the user can easily release the paint roller 4 from both roller end pieces 10, 20 and the bracket rod 3 without touching the same.

The inner roller end piece 10 comprises rotating divides that are disconnected from each other. The push-off element 15 is separately carried on the wheel 11. The wheel 11 is separately carried either directly on the bracket rod 3 or on the bearing 12. The wheel 11 comprises axial stop elements 112, 115, 116 for the push-off element 15 and constitutes a divide separate from the bracket 3 respectively the bearing 12 and is a disconnected rotational bearing for the push-off element 15. This disconnection means that independently of the load, the wheel 11 and the push-off element 15 can freely rotate with regard to the bracket rod 3. This disconnection means that independently of the load, the wheel 11 and the push-off element 15 can freely rotate with regard to the bearing 12. The bearing 12 is fixed in radial and axial direction on the bracket rod 3 after mounting for maintaining the inner roll end piece 10. The bearing 22 is fixed in radial and axial direction on the bracket rod 3 after mounting for maintaining the outer roll end piece 20. The bearing 12, 22 is mounted non-rotatably on the bracket rod 3 by friction. The bearing 12, 22 is thus fixed in axial and radial direction and non-rotatably on the bracket rod 3 by friction.

In accordance with the invention, also the bearing 22 in the outer roller end piece 20 may function in a correspondent way and present characteristics corresponding to the bearing 12 in the inner roller end piece 10, in particular the snap lock 16.

Other advantages of the invention consist in that it can be applied on any roller brackets, bracket rods and paint rollers. The invention can be used in standard solutions, such as all on the market known roller brackets with paint rollers and bracket rods that is this sector has standard dimensions, but it can also be used for special solutions of these divides. The dimensions of the bearing 12 can easily be adapted to present e. g. different inner diameters suitable for different bracket rods having various diameters.

1. A roller bracket for cooperation with a cylindrical paint roller, comprising a handle and a bracket rod, in which said roller bracket comprises an outer roller end piece arranged at the end of the bracket rod, and an inner roller end piece arranged at a distance from the outer roller end piece, said roller end pieces being arranged to removably carry the paint roller, said inner roller end piece comprising a wheel and a push-off element, whereby the wheel is rotatably mounted and axially movable between two positions, wherein the push-off element is rotatably mounted on the wheel and axially movable between two positions on the wheel, wherein said positions for the push-off element is defined by two stop elements on the wheel.

2. The roller bracket according to claim 1, wherein the wheel is rotatably mounted and axially movable between two positions on the bracket rod.

3. The roller bracket according to claim 1, wherein the roller end piece comprises a bearing for mounting in the wheel.

4. The roller bracket according to claim 1, wherein the roller bracket end pieces comprises a bearing for mounting on the bracket rod.

5. The roller bracket according to claim 3, wherein the bearing is arranged to be fixed non-rotatably on the bracket rod.

6. The roller bracket according to claim 3, wherein the bearing extends through the wheel.

7. The roller bracket according to claim 3, wherein the bearing extends through the entire axial length of the wheel.

8. The roller bracket according to claim 3, wherein the bearing is arranged to limit the movement of the wheel in axial direction by means of snap locks.

9. The roller bracket according to claim 8, wherein the bearing is arranged to limit the movement of the wheel in axial direction by means of a snap lock at one of its ends and a stop at the other end.

10. The roller bracket according to claim 1, wherein the push-off element comprises an annular projection along the outer circumference of the push-off element, which annular projection extends in the direction of the wheel after assembly of the wheel and the push-off element, wherein the diameter of the annular projection is larger than the diameter of the wheel and adapted to substantially correspond to the diameter of the paint roller.

11. The roller bracket according to claim 1, wherein the inner bearing is provided with at least one longitudinal groove that divides the inner bearing in the longitudinal direction of the inner bearing.

12. The roller bracket according to claim 1, wherein the wheel is provided with at least one longitudinal groove that divides the wheel in the longitudinal direction of the wheel.

13. The roller bracket according claim 12, wherein at least one longitudinal groove of the wheel divides an end of the wheel.

14. The roller bracket according to claim 1, wherein the wheel is arranged to limit the movement of the push-off element in axial direction by means of second stop elements and outer ridge in form of an abutment at one of its ends and in form of a first stop element at its other end.

15. The roller bracket according to claim 14, wherein the first stop element of the wheel is in form of at least one lug.

16. The roller bracket according to claim 3, wherein the push-off element comprises an annular projection along the outer circumference of the push-off element, which annular projection extends in the direction of the wheel after assembly of the wheel and the push-off element, wherein the diameter of the annular projection is larger than the diameter of the wheel and adapted to substantially correspond to the diameter of the paint roller, and
wherein the movement of the wheel in axial direction is limited by the bearing.

17. The roller bracket according to claim 3, wherein the push-off element comprises an annular projection along the outer circumference of the push-off element, which annular projection extends in the direction of the wheel after assembly of the wheel and the push-off element, wherein the diameter of the annular projection is larger than the diameter of the wheel and adapted to substantially correspond to the diameter of the paint roller, and
wherein the wheel is rotatably mounted on the bearing.

18. The roller bracket according to claim 1, wherein the push-off element comprises an annular projection along the outer circumference of the push-off element, which annular projection extends in the direction of the wheel after assembly of the wheel and the push-off element, wherein the diameter of the annular projection is larger than the diameter of the wheel and adapted to substantially correspond to the diameter of the paint roller, and wherein the wheel is rotatably mounted on the inner bearing and the wheel is in contact with at least one bearing surface of the inner bearing.

19. The roller bracket according to claim 1, wherein the wheel comprises a substantially cylindrical envelope surface, which is provided with a number of ribs distributed around the circumference of the envelope surface.

20. The roller bracket according to claim 19, wherein the ribs has the shape of a rounded out point that is radially thickest at an inner end of the wheel of the inner roller end and tapers toward the point in direction toward an another end of the wheel.

21. The roller bracket according to claim 10, wherein the push-off element comprises a substantially cylindrical hub that together with the annular projection of the push-off element provides a circumferential cup-like configuration.

22. A roller end piece for a roller bracket, wherein the bearing in the outer roller end piece corresponds to the bearing in the inner roller end piece according to claim 3.
